(19) United States
(12) Patent Application Publication
(10) Pub. No.: US 2009/0219888 A1
(43) Pub. Date: Sep. 3, 2009

(54) System and Method for Providing Connection Handoffs in Wireless Networks

(76) Inventors: Yong Chen, Plano, TX (US); Mazin Al-Shalash, Frisco, TX (US)

Correspondence Address: Slater & Matsil, L.L.P., 17950 Preston Road, Suite 1000, Dallas, TX, 75252, US

(21) Appl. No.: 12/203,794

(22) Filed: Sep. 3, 2008

Related U.S. Application Data
(60) Provisional application No. 61/032,729, filed on Feb. 29, 2008.

(51) Int. Cl. H04W 4/00

(52) U.S. Cl. 370/331

(57) ABSTRACT

System and method for providing connection handoffs from macrocell to femtocell in wireless networks. A method comprises determining a group identifier from a received pseudorandom number sequence, determining a list of access points from a plurality of access points, wherein the access points in the list of access points are all identified by a group identifier, transmitting a request for detecting an identifier of the communications device to each access point in the list of access points, receiving a positive acknowledgement from a locating access point in the list of access points, and locating the communications device in a coverage area of the locating access point. The acknowledgement indicates that the locating access point successfully detected the identifier.

This application claims the benefit of U.S. Provisional Application No. 61/032,729, filed on Feb. 29, 2008, entitled “Handoff from Macrocell to Femtocell of Radio Access Network,” which application is hereby incorporated herein by reference.

### TECHNICAL FIELD

The present invention relates generally to a system and method for wireless networks, and more particularly to a system and method for providing connection handoffs from a macrocell to a femtocell in wireless networks.

### BACKGROUND

In general, a cellular mobile communications system consists of a plurality of base stations (BS) that may be dispersed across a geographic service area. Each of the base stations may include at least an antenna and a base station transceiver system (BTS) providing wireless service to mobile stations (MS) within its service area. The BTS may be coupled to a base station controller (BSC), with each BSC connecting to a number of BTSs. The BSC may be coupled to either a mobile switching center (MSC) or a packet data services node (PDSN) via a packet control function (PCF), depending on whether circuit voice or packet switched data service is provided. Collectively, the BTS, BSC, and MSC or PCF/PDSN form a wireless network to provide wireless services.

The wireless network may operate using standardized protocols, one of which may be direct-sequence-spread-spectrum code division multiple access (CDMA) system. There are a number of evolutional protocols within the CDMA system, for example, CDMA2000 1x and 1xEV-DO. The CDMA2000 1x system may provide both circuit voice and data service, while the 1xEV-DO system provides packet switched data service at a high data rate.

In a CDMA system, the mobile stations operate on a single frequency channel, but may be given distinct (different) Walsh Codes, which may identify the mobile stations on a forward link (a uni-directional link between a base station and a mobile station), and distinct pseudorandom number (PN) long codes that may identify the mobile stations on a reverse link (a uni-directional link between a mobile station and a base station).

When a mobile station operating within a first sector served by a first BTS moves to a second sector serviced by a second BTS, a connection handoff between BTSs may be performed to provide continuous service to the mobile station. In a CDMA system, there may be several different types of handoffs, including a hard handoff, a soft handoff, and a softer handoff. The hard handoff may be a make-after-break process wherein a connection between the mobile station and the second BTS is established only after a connection between the mobile station and the first BTS is broken. The soft handoff and the softer handoff are make-before-break processes, wherein a connection between the mobile station and the second BTS is established before a connection between the mobile station and the first BTS is broken. The soft handoff also enables the mobile station to combine signals from two or more cells to obtain diversity gain. A softer handoff is a soft handoff with the two or more cells from a single BTS.

To assist in a connection handoff, the BTS and BSC may have a table called a neighbor list (NBL). The NBL may contain information such as PN sequence and cell identifier. Using the NBL, the BTS and/or the BSC may be able to identify a cell's identity according to a PN sequence received. The cell's identity may then be used to allocate resources as well as create a connection to replace the existing connection. However, due to implementation constraints, there may be a size limit on the NBL. For example, 20 entries may be a typical number on the size of the NBL. Depending on a BTS' type, the size limit may not be a significant limitation since there may generally be a limit on a number of neighboring cells.

Generally, with an outdoor BTS which may be a large scale device providing large area, high power, high capacity, and high reliability services, or a pico BTS which may be a small scale device providing low power, low capacity, and simplified functionality service suited for easy installation or distribution, the limited size of the NBL may not be a problem.

A femtocell is a term usually referring to a very small scale access point station that includes radio transceivers and channel elements, as well as some controller functionality. It may be considered to be a femto-sized BTS and BSC combined with low output power and small channel capacity designed for applications such as enhancing in-house coverage and integrated services using a broadband connection. The femtocells may be controlled by a femtocell gateway (FGW) via a broadband connection available at the location of the femtocells.

In certain applications, there may be a very large number of femtocells, on the order of tens, hundreds, or thousands. For example, in a large multi-family dwelling, such as an apartment building, or an office building, each room may be home to a femtocell. Therefore, when a mobile station moves into close proximity to such an installation, the mobile station may encounter a large number of femtocells. The large number of femtocells may quickly fill and then overflow the NBL of the BTS and BSC.

FIG. 1 is a diagram illustrating a portion of a communications network 100. The communications network 100 includes a plurality of base stations, such as base station 105, connected to a BSC 110, which in turn, may be connected to a MSC 115. The base station 105 may include a BTS 106 and an antenna 107. The base station 105 may have a coverage area 120 where it may be in communications with mobile stations, such as MS 125, MS 126, and MS 127. A base station's coverage area 120 may also be referred to as a macrocell.

As the MS 125 moves around in the coverage area 120, it may encounter a large cluster of femtocells (FC), such as FC 130, FC 131, FC 132, FC 133, and FC 134. In each femtocell, there may be a femtocell access point (FAP) providing connectivity to compatible mobile stations. The femtocells may be installed in an apartment building or an office building, for example.

When the MS 125 is communicating through a femtocell and moves away from the femtocell, necessitating a handoff from the femtocell to a base station, the handoff may be referred to as a handout. When the MS 125 is communicating through a base station and moves into range of a femtocell, necessitating a handoff from the base station to the femtocell, the handoff may be referred to as a handin. In general, a handout (femtocell to base station handoff) may not have a problem with NBL size due to the limited number of base stations. However, a handin (base station to femtocell handoff) may have problems with NBL size due to the typically large number of femtocells.

### SUMMARY OF THE INVENTION

These and other problems are generally solved or circumvented, and technical advantages are generally achieved, by embodiments of a system and a method for providing connection handoffs in wireless networks.

In accordance with an embodiment, a method for locating a communications device in a wireless network having a plurality of access points is provided. The method includes determining a group identifier from a received pseudorandom number (PN) sequence, determining a list of access points from the plurality of access points, wherein the access points in the list of access points are all identified by the group identifier, transmitting a request for detecting an identifier of the communications device to each access point in the list of access points, receiving a positive acknowledgement from a locating access point in the list of access points, and locating the communications device in a coverage area of the locating access point. The positive acknowledgement indicates that the locating access point successfully detected the identifier.

In accordance with another embodiment, a method for performing a connection handoff for a communications device is provided. The method includes receiving a connection handoff request, the connection handoff request containing a pseudorandom number (PN) sequence, determining a group identifier from the PN sequence, identifying a list of access points, with each access point in the list of access points having a group identifier identical to the group identifier, and transmitting a request for detecting the communications device to each access point in the list of access points. The method also includes in response to receiving a positive acknowledgement from a responding access point in the list of access points, the positive acknowledgement indicating that the responding access point successfully detected the communications device, transmitting the connection handoff request to the responding access point.

In accordance with another embodiment, a method for performing a connection handoff for a communications device is provided. The method includes receiving a message for detecting the communications device, attempting to detect the communications device, transmitting a positive acknowledgement in response to determining that the communications device was detected, and transmitting a negative acknowledgement in response to determining that the communications device was not detected.

In accordance with another embodiment, a communications gateway is provided. The communications gateway includes a memory comprising a database and a processor coupled to the memory. The database containing a list of access points coupled to the communications gateway, group identifiers of the access points, and cell identifiers of the access points, and the processor searches the database, transmits mobile station detect messages to access points in the database, and selects an access point base on its response to the mobile station detect message.

An advantage of an embodiment is that the size limitation of the neighbor list is overcome without requiring an increase in storage capabilities of the mobile stations. The additional hardware and software requirements may be implemented in femtocell gateways, which generally have sufficient additional resources.

A further advantage of an embodiment is that only on a femtocell that may actually be involved in a connection handoff would there be a need to reserve communications resources. This may simplify the connection handoff process as well as reducing a need for communications resources specifically dedicated for connection handoffs throughout the wireless network.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a diagram of a portion of a communications network;

FIG. 2a is a diagram of a portion of an internetwork operating system (IOS) based femtocell network;

FIG. 2b is a diagram of a portion of an IP multimedia subsystem (IMS) based femtocell network;

FIG. 3a is a diagram of a portion of a wireless network;

FIG. 3b is a diagram of a portion of a femtocell gateway;

FIG. 4 is a diagram of a neighbor list;

FIG. 5 is a diagram of an access point database;

FIG. 6 is a diagram of a portion of a wireless network;

FIG. 7 is a diagram of a sequence of events in the connection handoff for a mobile station;

FIG. 8 is a diagram of a connection handoff call flow for a 1x voice connection; and

FIG. 9 is a diagram of a connection handoff call flow for a 1xEV-DO connection.

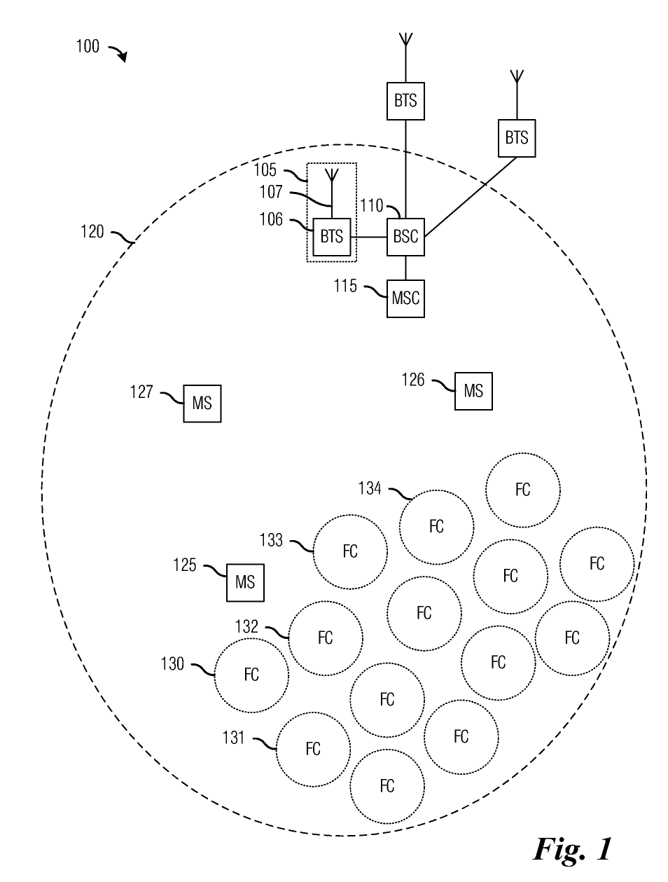

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely a wireless network using CDMA, such as CDMA2000 1x or 1xEV-DO compliant wireless networks. The invention may also be applied, however, to other wireless networks, such as time division multiple access (TDMA), frequency division multiple access (FDMA), and combinations thereof, wireless networks, wherein handoffs are supported and there may be more handoff candidates than there are entries in a neighbor list.

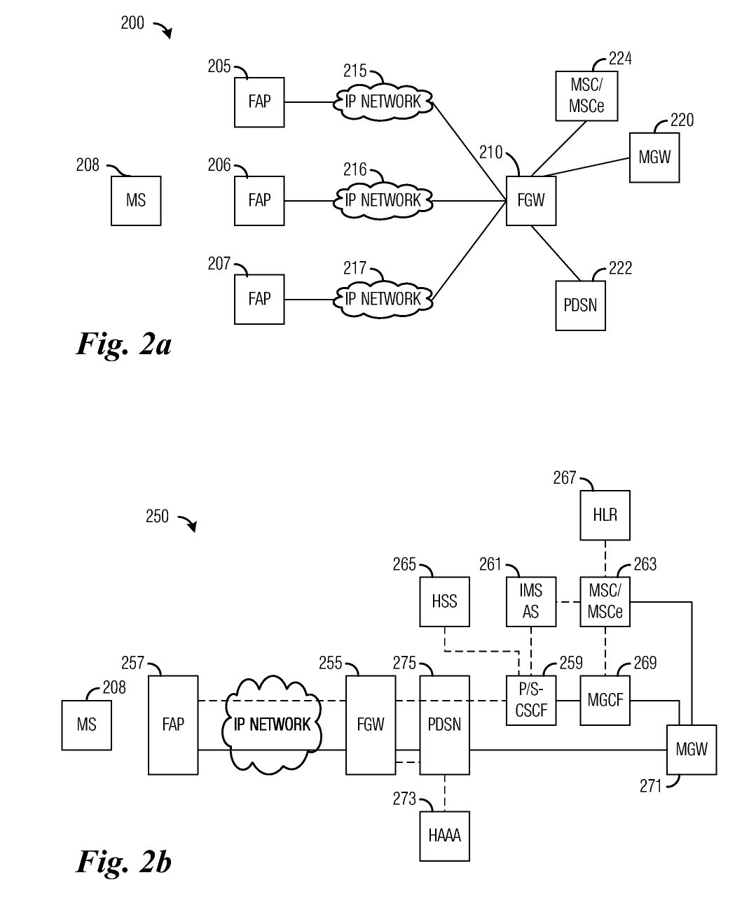

With reference now to FIG. 2a, there is shown a diagram illustrating an Interoperability Specification (IOS) based femtocell network 200. The femtocell network 200 includes multiple femtocell access points (FAP), such as FAP 205-207. A FAP may allow compatible mobile stations, such as MS 208, to access network resources. Each FAP may be controlled by a femtocell gateway (FGW) 210 through a connection, such as an Internet protocol (IP) network, such as IP networks 215-217. The FGW 210 may connect to a MSC/MSCe 224 via an A1/A1p interface for voice connections, and a packet data services node (PDSN) 222 via an A10/A11 interface for packet switched data service connections. A media gateway (MGW) 220 may provide media connectivity.

FIG. 2b is a diagram illustrating an IP multimedia subsystem (IMS) based femtocell network 250. The network 250 includes a FGW 255 acting as a session initiated protocol (SIP) client between a FAP 257 and a proxy/serving-call session control function (P/S-CSCF) unit 259. The FAP 257 may be used to convert A1p signaling to SIP signaling. Additionally, the FAP 257 may provide network access to the MS 208. An application server (IMS AS) 261 may include an application server function to convert an SIP signaling message back to an A1p for the MSC 263.

The network 250 may also include other components, such as a home subscriber server (HSS) 265, a home location registration (HLR) unit 267, a media gateway control function (MGCF) unit 269, a media gateway (MGW) 271, a home authentication authorization and accounting (HAAA) unit 273, and a packet data service network (PDSN) 275. These components may be used in providing connectivity to a home subscriber as well as distributing of media and multimedia content. Solid lines in FIG. 2b represent potential network traffic paths, while dotted lines show signaling paths.

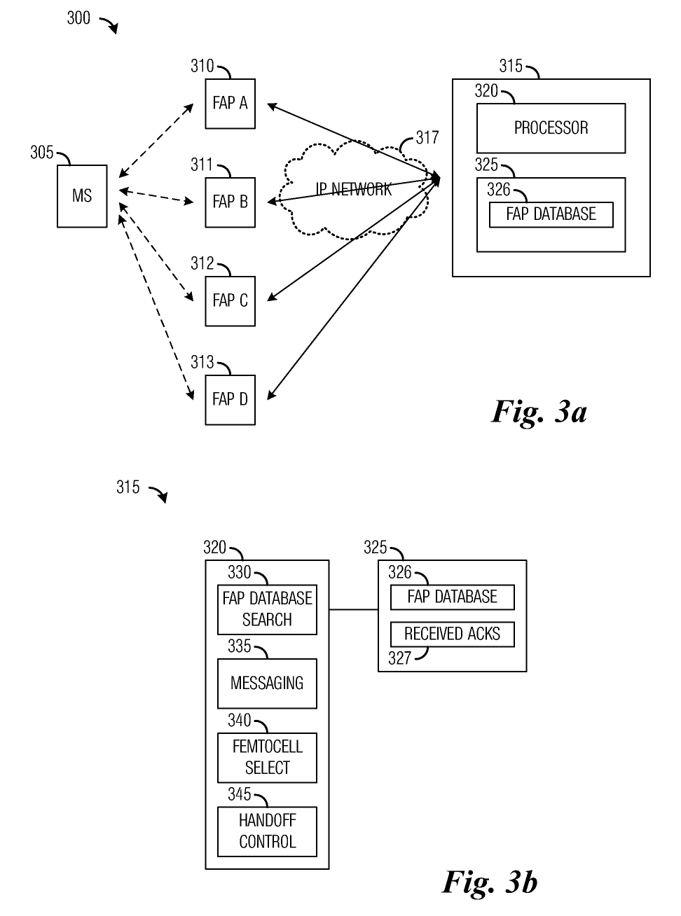

FIG. 3a is a diagram illustrating a portion of a wireless network 300. The wireless network 300 includes a MS 305. The MS 305 may move around and approaches a number of FAPs, such as FAP A 310, FAP B 311, FAP C 312, and FAP D 313. The FAPs may be controlled by a FGW 315, to which they may be connected via a network, such as an IP network 317. In addition to controlling the FAPs, the FGW 315 may provide a variety of network connectivity options for mobile stations connected to the FAPs. The FGW 315 includes a processor 320 and a memory 325.

As the MS 305 moves closer to some of the FAPs, such as the FAPs 310-313, the MS 305 begins to be able to detect transmissions from the FAPs 310-313. Additionally, the FAPs 310-313 may begin to be able to detect transmissions from the MS 305. As the signal strength of transmissions from the FAPs become stronger, a connection handoff may occur with the MS 305 and one of the FAPs.

Considering that a femtocell may have limited range, a small number of PN sequences may be used to represent all femtocells operating in a general area. Therefore, a single PN sequence may be used to identify a number of femtocells. However, by distributing the PN sequences over distance, it may be possible to assign PN sequences to femtocells so that femtocells using the same PN sequence may not be within operating range of one another.

By limiting the number of PN sequences used by the femtocells, instead of storing a unique identifier for every FAP that it is able to detect, the BTS and/or BSC may store a generic femto group identifier (FEMTO GROUP ID) associated with a PN sequence in the NBL. A single FEMTO GROUP ID may represent a number of unique FAPs. For example, if there are 100 FAPs operating in a macrocell and there are 30 generic femto group identifiers, then, on average, each generic femto group identifier may correspond to three FAPs. Hence a FEMTO GROUP ID stored in the NBL may represent a number of unique FAPs.

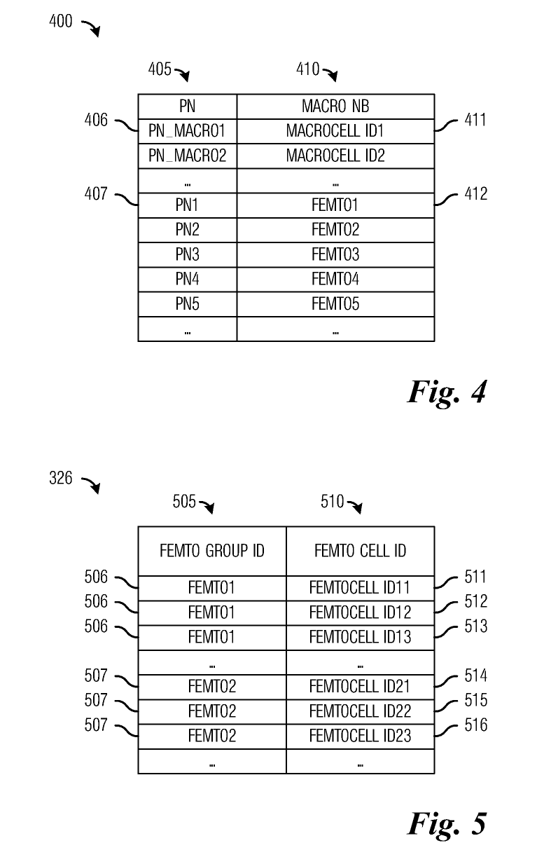

FIG. 4 is a diagram illustrating a NBL 400. The NBL 400 may include two sets of entries. A first set of entries (shown as column 405) may be a list of PN sequences and a second set of entries (shown as column 410) may be a list of identifiers. The PN sequences in the first set of entries 405 may be PN sequences for macrocells, such as PN_MACRO1 406, or PN sequences corresponding to a number of FAPs, such as PN1 407. If the PN sequence is a PN sequence for a macrocell, then a macrocell identifier may be stored in a corresponding slot in the second set of entries 410. For example, MACROCELL ID1 411 may correspond to PN sequence PN_MACRO1 406. If the PN sequence is a PN sequence for a number of FAPs, then a FEMTO GROUP ID may be stored in a corresponding slot in the second set of entries 410. For instance, FEMTO1 412 may be a FEMTO GROUP ID corresponding to PN sequence PN1 407.

Referring back now to FIG. 3a, however, a single FEMTO GROUP ID representing a number of unique FAPs may lead to confusion while communicating, attempting to perform a handoff, and so forth, since it may be difficult to determine which FAP the MS 305 is actually trying to communicate with.

Since the FGW 315 controls the operation of the FAPs, the FGW 315 may be helpful in resolving the confusion. In the memory 325, the FGW 315 may contain a FAP database 326, which contain entries mapping FEMTO GROUP IDs to unique femtocells. The FAP database 326 may be used by the FGW 315 to coordinate connection handoffs for the MS 305 between a macrocell and the FAPs. For example, if a BTS and BSC determines that the MS 305 should perform a call handoff to a FAP identified by a PN sequence provided by the MS 305, the BTS and BSC may provide a generic femtocell group identifier (FEMTO GROUP ID) corresponding to the PN sequence (as stored in the NBL) to the FGW 315, which may then use the FAP database 326 to help identify the FAPs corresponding to the generic femtocell group identifier (FEMTO GROUP ID). The FGW 315 may then help determine which FAP associated with the generic femtocell group identifier (FEMTO GROUP ID) the MS 305 may perform a connection handoff with.

FIG. 5 is a diagram a FAP database 326. The FAP database 326 may be typical of a FAP database contained in a femtocell gateway, such as the FGW 315. The FAP database 326 may include two sets of entries. A first set of entries (shown as column 505) may be a list of generic femtocell group identifiers (FEMTO GROUP IDs) and a second set of entries (shown as column 510) may be a list of femtocell identifiers (FEMTO CELL IDs) corresponding to the generic femtocell group identifiers (FEMTO GROUP IDs). For example, FEMTO GROUP ID FEMTO1 506 may correspond to three FAPs, specifically, FAPs having FEMTO CELL IDs: FEMTOCELL ID11 511, FEMTOCELL ID12 512, and FEMTOCELL ID13 513. Similarly, FEMTO GROUP ID FEMTO2 507 may correspond to three FAPs, specifically, FAPs having FEMTO CELL IDs: FEMTOCELL ID21 514, FEMTOCELL ID22 515, and FEMTOCELL ID23 516. The FAP database 326 may have a copy of the FEMTO GROUP ID for each unique FEMTO CELL ID as shown in FIG. 5, or the FAP database 326 may have a single entry for each FEMTO GROUP ID and then the unique FEMTO CELL IDs may be stored in a list associated with the FEMTO GROUP IDs.

FIG. 3b is a diagram illustrating a portion of the FGW 315 in detail. The FGW 315 includes the processor 320 and the memory 325. The processor 320 may be used to perform operations such as controlling the operation of FAPs connected to the FGW 315, provide network connectivity to mobile stations connected to the FAPs, and so forth. The memory 325 may be used to store data and information, such as the FAP database 326, for example.

The processor 320 includes a FAP database search unit 330 that may be used to search the FAP database 326 stored in the memory 325, with the search being based on the generic femtocell group identifier (FEMTO GROUP ID) provided by the BTS and BSC. The FAP database search unit 330 may search the FAP database 326 using the generic femtocell group identifier (FEMTO GROUP ID) and return FEMTO CELL IDs associated with the generic femtocell group identifier (FEMTO GROUP ID). The processor 320 may also include a messaging unit 335. The messaging unit 335 may be used to transmit messages to FAPs having the FEMTO CELL IDs returned by the FAP database search unit 330. The messages may request that the FAPs having the FEMTO CELL IDs attempt to detect an identifier of the MS 305, possibly indicating that the FAP may be the connection handoff target. For example, the messages may request that the FAPs detect a long code mask of the MS 305. The long code mask may be transmitted by the mobile stations, including the MS 305, of the wireless network 300.

The processor 320 may also include a femtocell select unit 340. After the messaging unit 335 transmits the messages to the FAPs having the FEMTO CELL IDs returned by the FAP database search unit 330 requesting that each FAP detect the identifier that identifies the MS 305, each FAP may respond to the messages with an acknowledgement (either a positive or a negative acknowledgement). The acknowledgement may say that the FAP was or was not able to detect the identifier that uniquely identifies the MS 305. The acknowledgments may be stored in a received acknowledgement store 327 in the memory 325. For example, if told to detect the long code mask of the MS 305, the FAPs may return acknowledgments back to the FGW 315 specifying whether or not they were able to detect the long code mask of the MS 305. If a FAP was able to detect the identifier of the MS 305, then it may be possible that the FAP is the connection handoff target.

It may be possible that more than one FAP may be able to detect the identifier of the MS 305. Each FAP would then return a positive acknowledgement. If this is the case, then the femtocell select unit 340 may select one of the FAPs from the multiple FAPs. The selection of the FAP may be based on factors such as an indicator of a detected signal quality of the identifier of the MS 305, a number of mobile stations already connected to the FAP, the type of network traffic being handled by the FAP, and so forth. An example of an indicator of detected signal quality may be a frame reception success rate, received signal strength indication (RSSI), and so on.

After the FAP responding with a positive acknowledgement (or the FAP selected from multiple FAPs responding with positive acknowledgements) has been selected by the femtocell select unit 340, a connection handoff may be initiated and controlled by a handoff control unit 345. For example, the handoff control unit 345 may initiate a setup of network resources at the FAP needed for the connection handoff, and send information regarding the network resources at the FAP to a macro system that includes the FAP and the MS 305, which may start the connection handoff process.

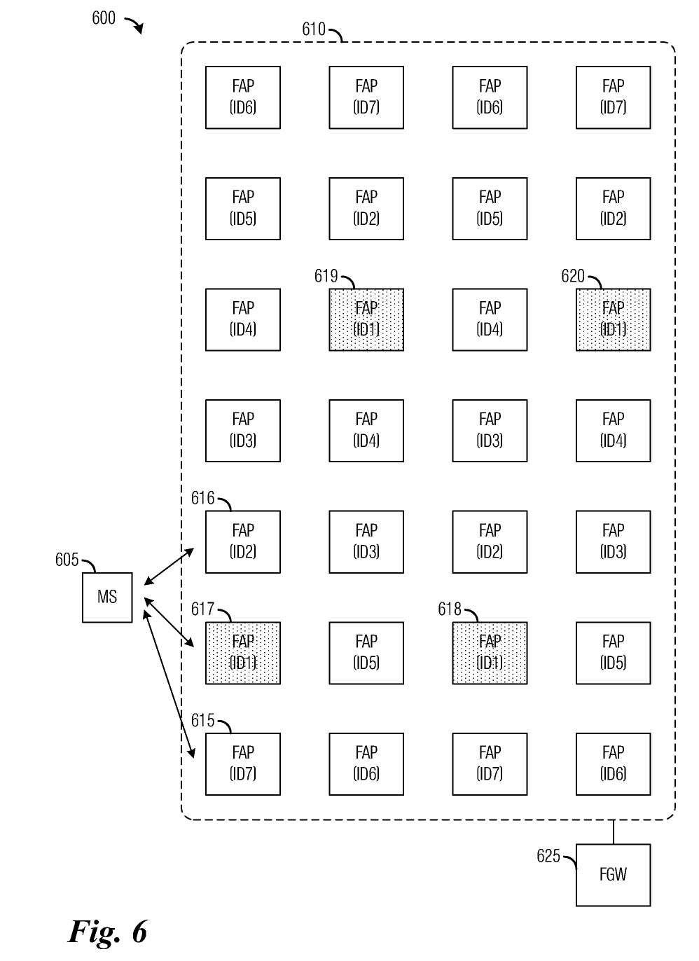

FIG. 6 is a diagram of a wireless network 600. The wireless network 600 includes a mobile station MS 605. The MS 605 may be currently connected to the wireless network 600 through a macrocell (not shown). However, as the MS 605 moves around, it encounters a cluster of FAPs 610. The cluster of FAPs 610 comprises a large number of FAPs, such as FAP 615, FAP 616, and FAP 617. The cluster of FAPs 610 may have a number of FAP groups. Each FAP group may include more than one FAP, with each FAP in a FAP group being assigned a generic femtocell group identifier FEMTO GROUP ID. However, each FAP in a FAP group has a unique femtocell identifier FEMTO CELL ID. For example, FAP 615 is a member of a FAP group with FEMTO GROUP ID ID7, FAP 616 is a member of a FAP group with FEMTO GROUP ID ID2, and FAP 617 is a member of a FAP group with FEMTO GROUP ID ID1. Other members of the FAP group with FEMTO GROUP ID ID1 may include FAP 618, FAP 619, and FAP 620.

As the MS 605 moves closer to the cluster of FAPs 610, received signal strengths from the FAPs in the cluster of FAPs 610 may begin to approach and exceed received signal strength from the macrocell. For discussion purposes, let the macrocell decide that it has determined that the MS 605 should perform a connection handoff from the macrocell to one of the FAPs in the cluster of FAPs 610. The BTS and BSC may provide a PN sequence of a FAP that it wishes the MS 605 perform the connection handoff with. For example, the MS 605 may have received a pilot beacon containing a PN sequence from a FAP with a generic femtocell group id and the MS 605 may have initiated the connection handoff as a result of receiving the pilot beacon. For example, the MS 605 may have received a pilot beacon containing a PN sequence from a FAP having generic femtocell group id FEMTO GROUP ID ID1 (such as, FAP 617).

However, since there are four FAPs (FAP 617, FAP 618, FAP 619, and FAP 620) in the cluster of FAPs 610 with the generic femtocell group id FEMTO GROUP ID ID1 (as determined by accessing an FAP database), there may be difficulty in determining which FAP will perform the connection handoff with the macrocell. To determine the FAP that may perform the connection handoff with the macrocell, a FGW 625 (i.e., the messaging unit 335) after determining which FAPs correspond to the generic femtocell group id (using the FAP database search unit 330, for example) may transmit a message to all FAPs with the generic femtocell group id FEMTO GROUP ID ID1, namely FAPs 617-620. The message may request that the FAPs 617-620 attempt to detect an identifier (such as a long code mask) of the MS 605.

Since the ability to detect the long code mask of the MS 065 may depend on the closeness of a FAP to the MS 605, it may be likely that a FAP out of the FAPs 617-620 that is closest to the MS 605 will have the greatest chance of detecting the long code mask, especially with a high frame reception success rate. The FAP(s) successfully detecting the long code mask of the MS 605 may return a positive acknowledgement to the FGW 625, while the FAPs unsuccessfully detecting the long code mask of the MS 605 may return a negative acknowledgement to the FGW 625.

The FGW 625 (i.e., the femtocell select unit 340) may select the FAP returning the positive acknowledgement as the FAP that will perform the connection handoff with the macrocell. For discussion purposes, let the FAP 617 be the FAP that returns the positive acknowledgement. If more than one FAP returns a positive acknowledgement, then the FGW 625 may select the FAP with highest frame reception success rate, RSSI, least busy, and so forth. With the FAP selected (FAP 617), the FGW 625 may continue with the connection handoff.

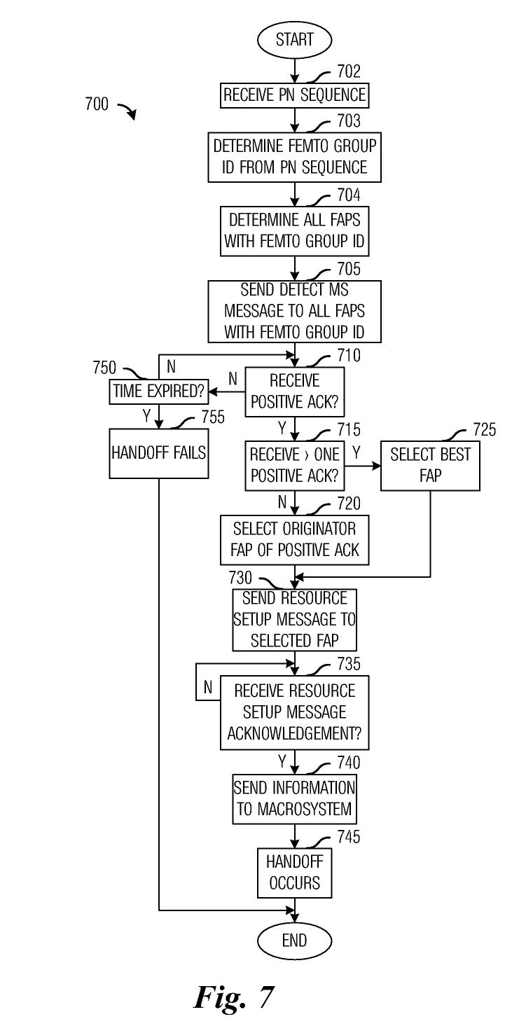

FIG. 7 is a diagram illustrating a sequence of events 700 in the connection handoff for a mobile station, wherein the connection handoff occurs between a macrocell and a femtocell. The sequence of events 700 may be a description of events occurring in a FGW, such as the FGW 315, as a mobile station, such as MS 305, attempts a connection handoff. The connection handoff may begin a determination of a generic femtocell group id for a FAP from a PN sequence that the MS 305 wishes to perform a macrocell to femtocell connection handoff with. The generic femtocell group id may be determined from the NBL.

Since the generic femtocell group id may correspond to a number of FAPs, a connection handoff may not be performed with an arbitrary FAP with the generic femtocell group id because the arbitrary FAP may be out of communications range with the MS 305. The MS 305 may provide the PN sequence to the FGW 315 (block 702) and the FGW 315 may determine a generic femtocell group id from the PN sequence (block 703). From the generic femtocell group id, the FGW 315 may be able to determine all FAPs having the generic femtocell group id (block 704). The FGW 315 may utilize a FAP database stored in its memory to determine the FAPs with the generic femtocell group id. The FGW 315 may then transmit a message to the FAPs (block 705). The message may request that the FAPs attempt to detect identifying information regarding the MS 305. An example of the identifying information may be the MS's long code mask.

FAPs receiving the message may then attempt to detect the identifying information of the MS 305. Based on their ability to detect the identifying information, the FAPs may either return a positive acknowledgement (indicating that the FAP was able to detect the identifying information) or a negative acknowledgement (indicating that the FAP was not able to detect the identifying information) to the FGW 315. A check may be made to determine if the FGW 315 has received a positive acknowledgement (block 710). If the FGW 315 has received a positive acknowledgement, then another check may be made to determine if the FGW 315 has received more than one positive acknowledgement (block 715).

If the FGW 315 is required to wait more than a specified amount of time to receive a positive acknowledgement(s) from FAPs having the generic femtocell group id (block 750), then the FGW 315 may simply fail the connection handoff attempt (block 755). However, if the specified amount of time has not elapsed, then the FGW 315 may continue to wait for the positive acknowledgement(s) to arrive (block 710).

If the FGW 315 has received only a single positive acknowledgement (block 715), then the FAP that returned the positive acknowledgement may be selected (block 720). If the FGW 315 has received multiple positive acknowledgements (block 715), then the FGW 315 may selected one of the FAPs (block 725). The selection of the FAP may make use of criteria such as detected frame success rate, RSSI, FAP business/idleness, and so forth.

After selecting the FAP (block 720 or block 725), the FGW 315 may transmit a resource setup message to the selected FAP (block 730). The resource setup message may instruct the selected FAP to reserve the resources necessary to continue the connection that the MS 305 has with the macrocell. For example, the FAP may need to reserve adequate resources to meet bandwidth, quality of service (QoS) guarantees, latency, throughput, and so forth, requirements.

If the selected FAP successfully reserves the resources, the selected FAP may return an acknowledgement indicating that it has successfully reserved the resources. The FGW 315 may wait until it receives the acknowledgement (block 735). In an alternative embodiment, if the FGW 315 does not receive the acknowledgement after a specified period of time, the FGW 315 may repeat the operations to select a FAP to perform the connection handoff (blocks 705-730) excluding the selected FAP or the FGW 315 may simply fail the connection handoff attempt.

Once the FGW 315 receives the acknowledgement from the selected FAP indicating that it has reserved the resources, then the FGW 315 may transmit information related to the reserved resources, the selected FAP, and so forth, to the macrosystem (block 740). This may be necessary to initiate the actual connection handoff between the macrocell and the selected FAP. Then, the connection handoff may actually occur (block 745) and the sequence of events 700 may terminate.

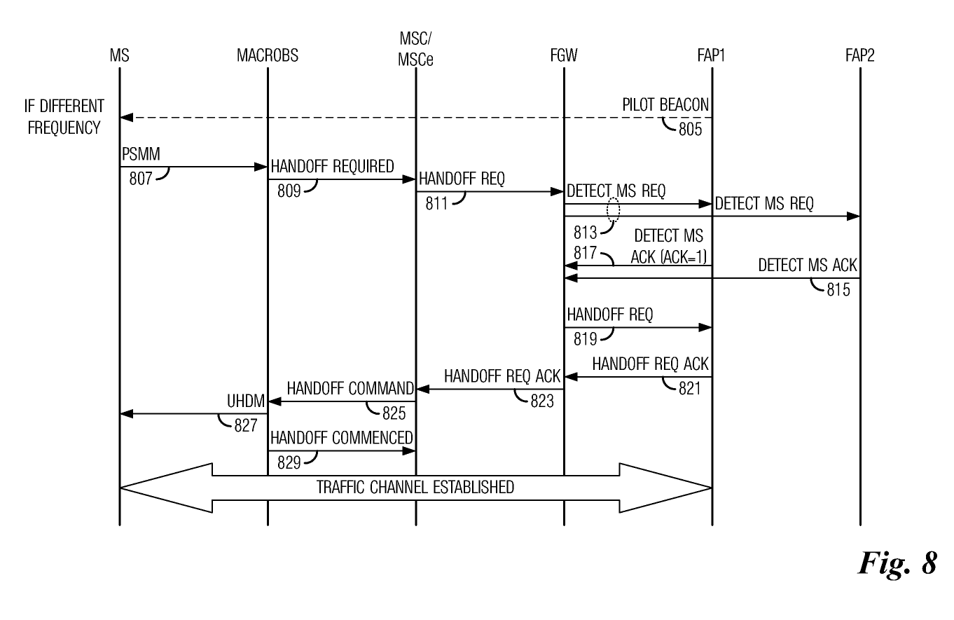

FIG. 8 is a diagram illustrating a connection handoff call flow for a 1x voice connection. The connection handoff call flow for a 1x voice connection may begin with a FAP, such as FAP1, transmitting a pilot beacon 805 that may be received by a mobile station, such as MS. As a result of the pilot beacon 805, the MS may report information related to the pilot to a macro base station, such as the MACROBS, in a pilot strength measurement message (PSMM) 807.

Based on the PSMM 807, the MACROBS may determine that a connection handoff may be needed. The MACROBS may indicate this by transmitting a handoff required message 809 to a MSC/MSCe. The handoff required message 809 may contain a list of FAPs corresponding to a PN sequence of FAP1 contained in the pilot beacon 805. The list of FAPs may have the appearance of a neighbor list. When the MSC/MSCe receives the handoff required message 809, the MSC/MSCe may transmit a handoff request message 811 to a FGW that may have registered the FAP1. The handoff request message 811 may include an IS-2000 channel identity element and/or A2p bearer parameters.

Upon receiving the handoff request message 811, the FGW may initiate a long code mask (or some other unique identifier) detection procedure by sending a detect MS request message 813 to each FAP in the list of FAPs received in the handoff required message 809. As the FAPs in the list of FAPs perform and complete the long code mask detection procedure, the FAPs may return an indication of the result of the long code mask detection procedure to the FGW in the form of a detect MS acknowledgement, with the value of the acknowledgement indicating the result. For example, FAP2 may return a detect MS acknowledgement 815 with a value that indicates that it was not able to detect the long code mask of the MS, while FAP1 may return a detect MS acknowledgement 817 with a value that indicates that it was able to detect the long code mask of the MS (for example, acknowledgement=1).

In addition to receiving an acknowledgement from the FAPs in the list of FAPs, a FGW may determine that a FAP may not have been able to detect the long code mask of the MS if, after a specified amount of time, the FGW does not receive an acknowledgement of any form from the FAP.

After receiving the detect MS acknowledgement 817 with a value indicating that the FAP1 was able to detect the long code mask of the MS, the FGW may forward a handoff request message 819 to the FAP1. The handoff request message 819 may contain substantially the same information as the handoff request message 811. If the FGW received detect MS acknowledgements from multiple FAPs indicating success in detecting the long code mask of the MS, the FGW may compare detection results (also contained in the detect MS acknowledgements) and select a FAP to handle the connection handoff based on the detection results.

After receiving the handoff request message 819, the FAP1 may then allocate an appropriate amount of network resources and return a handoff request acknowledgement 821 to the FGW. The handoff request acknowledgement 821 may include information such as reserved bearer format(s), bearer address of the BS, and so forth. The FGW may then forward the handoff request acknowledgement 821 (a handoff request acknowledgement 823) to the MSC/MSCe.

The MSC/MSCe may then prepare to switch the MS from the MACROBS to the FAP1. This may be followed by the MSC/MSCe transmitting a handoff command message 825 to the MACROBS. When the MACROBS receives the handoff command message 825 from the MSC/MSCe, the MACROBS may send a universal handoff direction message (UHDM) 827 to the MS. The UHDM 827 may be used to indicate to the MS the femtocell identifier (FEMTO CELL ID) of the FAP1. The MACROBS may also send a handoff commenced message 829 to the MSC/MSCe. The handoff commenced message 829 may be used to notify the MSC/MSCe that the MS has been ordered to move over to network resources reserved by the FAP1. After the MSC/MSCe has been notified, the traffic channel between the MS and the FAP1 has been established.

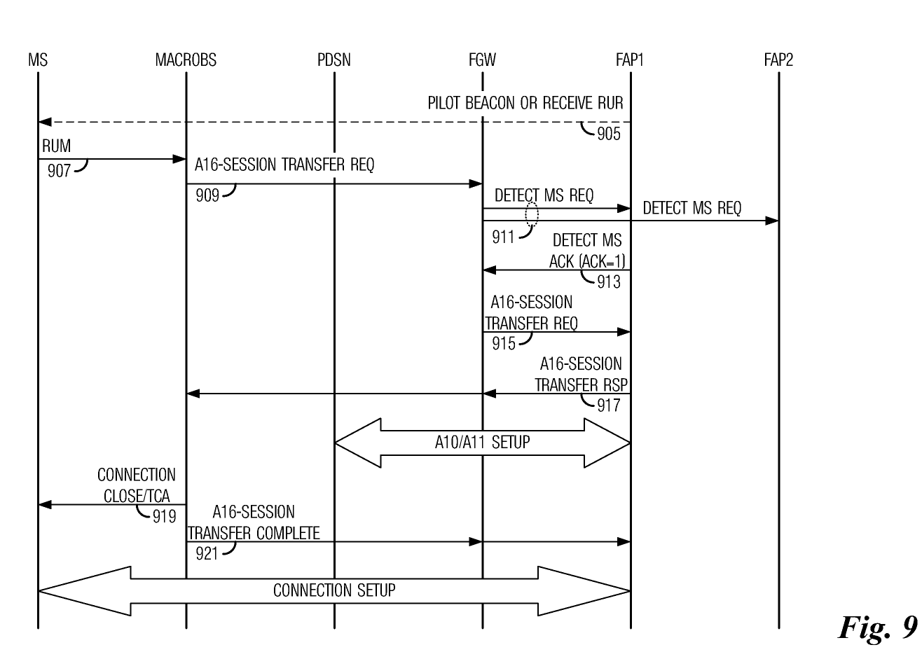

FIG. 9 is a diagram illustrating a connection handoff call flow for a 1xEV-DO connection. The connection handoff call flow for a 1x voice connection may begin with a FAP, such as FAP1, transmitting a pilot beacon (or a receive route update radius (RUR)) 905 that may be received by a mobile station, such as MS. Upon receipt of the pilot beacon (or receive RUR) 905, the MS may transmit a route update message (RUM) 907 to a macro BS (MACROBS). The MACROBS may, in turn, transmit an A16 session transfer request 909 to a femtocell gateway (FGW). The A16 session transfer request 909 may include a list of FAPs that corresponds to a PN sequence detected in the pilot beacon (or receive RUR) 905. The FGW may transmit a detect MS request 911 to the FAPs in the list of FAPs. The detect MS request 911 may request the FAPs to perform a long code mask (or some other unique identifier of the MS) detect procedure.

The FAPs performing the long code mask detect procedure may respond to the FGW's detect MS request by transmitting a detect MS acknowledgement with the acknowledgement value being dependent on the results of the long code mask detect procedure. For example, FAP1 may respond with a detect MS acknowledgement 913 with the acknowledgement value indicating that it was able to detect the long code mask of the MS. The FGW upon receiving the detect MS acknowledgement 915 from the FAP1, may transmit an A16 session transfer request 915 to the FAP1, which may result in the FAP1 reserving network resources based on information contained in the A16 session transfer request 915. After reserving the network resources, the FAP1 may respond to the FGW with an A16 transfer response 917 that may indicate results of the reservation of the network resources. The FGW may forward the A16 transfer response 917 to the MACROBS. This may complete an A10/A11 connection between the FAP1 and a packet data service network, such as the PSDN.

The MACROBS may then transmit a connection close/traffic channel assignment (TCA) message 919 to the MS as well as an A16 session transfer complete message 921 to the FGW, which may then forward it to the FAP1. The connection between the MS and the FAP1 may now be complete.

Although the embodiments and their advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for locating a communications device in a wireless network having a plurality of access points, the method comprising:
determining a group identifier from a received pseudorandom number (PN) sequence;
determining a list of access points from the plurality of access points, wherein the access points in the list of access points are all identified by the group identifier;
transmitting a request for detecting an identifier of the communications device to each access point in the list of access points;
receiving a positive acknowledgement from a locating access point in the list of access points, the positive acknowledgement indicating that the locating access point successfully detected the identifier; and
locating the communications device in a coverage area of the locating access point.

2. The method of claim 1, wherein the receiving a positive acknowledgement comprises:
receiving positive acknowledgements from a set of responding access points in the list of access points; and
selecting the locating access point from the set of responding access points based on a quality indicator.

3. The method of claim 2, wherein the quality indicator is a detected frame success rate or a received signal strength indication.

4. The method of claim 1, wherein the determining a list of access points comprises retrieving the list of access points from a database of access points.

5. The method of claim 4, wherein the database is stored on an electronic device performing the method.

6. The method of claim 1, wherein the request for detecting an identifier comprises a request for detecting a long code mask of the communications device.

7. A method for performing a connection handoff for a communications device, the method comprising:
receiving a connection handoff request, the connection handoff request containing a pseudorandom number (PN) sequence;
determining a group identifier from the PN sequence;
identifying a list of access points, with each access point in the list of access points having a group identifier identical to the group identifier;
transmitting a request for detecting the communications device to each access point in the list of access points; and
in response to receiving a positive acknowledgement from a responding access point in the list of access points, the positive acknowledgement indicating that the responding access point successfully detected the communications device, transmitting the connection handoff request to the responding access point.

8. The method of claim 7, further comprising after the transmitting the connection handoff, receiving a handoff request acknowledgement message from the responding access point.

9. The method of claim 7, wherein the identifying a list of access points comprises:
searching a database of access points with the group identifier; and
placing access points having a group identifier identical to the group identifier in the list of access points.

10. The method of claim 7, further comprising in response to receiving multiple positive acknowledgements from more than one responding access points in the list of access points, the positive acknowledgements indicating that the more than one responding access points successfully detected the communications device:
selecting an access point from the more than one responding access points; and
transmitting the connection handoff request to the selected access point.

11. The method of claim 10, wherein the selecting is based on a quality indicator provided by each responding access point.

12. The method of claim 11, wherein the quality indicator is a detected frame success rate or received signal strength indication.

13. The method of claim 7, further comprising in response to receiving only negative acknowledgements from responding access points in the list of access points, the negative acknowledgement indicating that the responding access point was not able to successfully detect the communications device, failing the connection handoff.

14. A method for performing a connection handoff for a communications device, the method comprising:
receiving a message for detecting the communications device;
attempting to detect the communications device;
transmitting a positive acknowledgement in response to determining that the communications device was detected; and
transmitting a negative acknowledgement in response to determining that the communications device was not detected.

15. The method of claim 14, further comprising:
receiving a connection handoff request message;
reserving network resources based on the handoff request message; and
transmitting a message indicating a successful reservation of network resources.

16. The method of claim 14, wherein the attempting to detect comprises attempting to detect a unique identifier of the communications device.

17. The method of claim 16, wherein the unique identifier is a long code mask.

18. A communications gateway comprising:
a memory comprising a database, the database containing a list of access points coupled to the communications gateway, group identifiers of the access points, and cell identifiers of the access points; and
a processor coupled to the memory, the processor configured to search the database, to transmit mobile station detect messages to access points in the database, and to select an access point based on its response to the mobile station detect message.

19. The communications gateway of claim 18, wherein the processor comprises:
a database search unit configured to search the database and to identify at least one access point in the database corresponding to a group identifier;
a messaging unit coupled to the database search unit, the messaging unit configured to transmit the mobile station detect messages to access points identified by the database search unit; and
an access point select unit coupled to the database search unit, the access point select unit configured to select an access point from the access points identified by the database search unit based on received acknowledgements to the mobile station detect messages.

20. The communications gateway of claim 18, wherein the communications gateway is a part of a 1xEV-DO compliant communications network.

21. The communications gateway of claim 18, wherein the communications gateway is a part of a CDMA2000 1x compliant communications network.
